(19) United States
(12) Patent Application Publication
(10) Pub. No.: US 2024/0329968 A1
(43) Pub. Date: Oct. 3, 2024

(54) SEAFLOOR OBSERVATION APPARATUS, SEAFLOOR OBSERVATION SYSTEM, CONTROL METHOD, AND PROGRAM

(71) Applicant: NEC Corporation, Tokyo (JP)

(72) Inventor: Tsubasa ASAI, Tokyo (JP)

(73) Assignee: NEC Corporation, Tokyo (JP)

(21) Appl. No.: 18/410,287

(22) Filed: Jan. 11, 2024

(30) Foreign Application Priority Data
Mar. 29, 2023 (JP) 2023-053060

(51) Int. Cl. G06F 8/65; H01B 7/14

(52) U.S. Cl. CPC G06F 8/65; H01B 7/14

(57) ABSTRACT

A seafloor observation apparatus according to an example embodiment includes: a plurality of sensors including sensors of different types installed under the sea in an observation sea area; a storage unit configured to store software used for processing of sensor signals output from the plurality of sensors; a control unit capable of updating the software in response to update data transmitted from a land station through a submarine cable; a processing unit configured to generate observation data by performing processing of a sensor signal of each of the plurality of sensors by using the software; and a communication unit configured to transmit the observation data to the land station through the submarine cable.

### INCORPORATION BY REFERENCE

This application is based upon and claims the benefit of priority from Japanese patent application No. 2023-53060, filed on Mar. 29, 2023, the disclosure of which is incorporated herein in its entirety by reference.

### TECHNICAL FIELD

The present disclosure relates to a seafloor observation apparatus, a seafloor observation system, a control method, and a program.

### BACKGROUND ART

A seafloor observation system is a system that is constructed by connecting seafloor observation apparatuses including sensors such as a water pressure gauge, a velocity gauge, and an accelerometer through submarine cables, and observes physical phenomena occurring on the seafloor by receiving signals transmitted from the seafloor observation apparatuses at a land station. A seafloor observation system that has been installed in the past includes thousands of kilometers of cables and a plurality of seafloor observation apparatuses. One seafloor observation apparatus includes a plurality of types of sensors and, for redundancy, includes a plurality of sensors of the same type.

Japanese Utility Model Registration No. 3130012 discloses a magnetic sensor installed on the seafloor. This magnetic sensor includes a magnetic sensor main body, an optical communication device, and a feeding branch part. A feeder (e.g., a power supply line) connected to the feeding branch part and an optical fiber connected to the optical communication device are connected to a feeding part (e.g., a power supply unit) and a data communication device, respectively, installed on land.

The magnetic sensor main body includes a magnetic-field detection unit, a signal processing unit, and a transmission circuit. The magnetic-field detection unit and the signal processing unit are controlled by software installed therein and measure data such as 3D (three-dimensional) terrestrial magnetism. The data measured by the magnetic-field detection unit and the signal processing unit are input to and analyzed by the data communication device installed on land. Further, data that are used to, for example, make changes to the software or rewrite calibration data are input from the data communication device to the signal processing unit, so that, for example, changes are made to the software or the calibration data is rewritten.

As described above, the seafloor observation apparatus observes physical phenomena occurring on the seafloor by performing data processing on signals output from sensors (hereinafter also referred to as sensor signals). Since the seafloor observation apparatus includes a plurality of sensors of different types, it is necessary to process both a large number of types of signals and signals of a large number of sensors. Further, the environments around seafloor observation apparatuses also differ from each other due to, for example, the influence of the pressure or the water flow which differs from one environment to another due to the difference between the depths of the places where the seafloor observation apparatuses are installed. Therefore, there is a problem that if sensors of seafloor observation apparatuses installed in different places are calibrated under the same conditions, errors of calculation results increase when sensor signals output from sensors are converted into actual physical values (observation data).

### SUMMARY

In view of the above-described problem, an object of the present disclosure is to provide a seafloor observation apparatus, a seafloor observation system, a control method, and a program capable of performing accurate data processing on sensor signals output from a plurality of sensors even when the place where the seafloor observation apparatus is installed is different.

A seafloor observation apparatus according to an aspect of the present disclosure includes a plurality of sensors including sensors of different types, a storage unit, a control unit, a processing unit, and a communication unit. The plurality of sensors are installed under the sea in an observation sea area. The storage unit stores software used to process sensor signals output from the plurality of sensors. The control unit can update the software in response to update data transmitted from a land station through a submarine cable. The processing unit generates observation data by performing processing on a sensor signal of each of the plurality of sensors by using the software. The communication unit transmits the observation data to the land station through the submarine cable.

A seafloor observation system according to an aspect of the present disclosure includes a plurality of seafloor observation apparatuses, each of which is one described above, connected by submarine cables, and a land station. The land station transmits update data for updating the software to the seafloor observation apparatuses through the submarine cables.

In a control method according to an aspect of the present disclosure, a computer performs the following processes.

A process for generating sensor signals by using a plurality of sensors including sensors of different types installed under the sea in an observation sea area.

A process for generating observation data by performing processing on a sensor signal of each of the plurality of sensors by using software used to process sensor signals output from the plurality of sensors, the software being updatable in response to update data transmitted from a land station through a submarine cable.

A process for transmitting the observation data to the land station through the submarine cable.

A program according to an aspect of the present disclosure causes a computer to perform the following processes.

A process for generating sensor signals by using a plurality of sensors including sensors of different types installed under the sea in an observation sea area.

A process for generating observation data by performing processing on a sensor signal of each of the plurality of sensors by using software used to process sensor signals output from the plurality of sensors, the software being updatable in response to update data transmitted from a land station through a submarine cable.

A process for transmitting the observation data to the land station through the submarine cable.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing a functional configuration of a seafloor observation apparatus according to a first example embodiment;

FIG. 2 shows a configuration of a seafloor observation system according to a second example embodiment; and

FIG. 3 is a flow diagram for explaining a method for controlling a seafloor observation system according to the second example embodiment.

### EXAMPLE EMBODIMENT

An example embodiment will be described hereinafter with reference to the drawings. Note that in the example embodiment, the same reference numerals (or symbols) are assigned to the same or equivalent elements, and redundant descriptions thereof are omitted. The example embodiment relates to a seafloor observation apparatus that is installed on the seafloor and includes a plurality of sensors including sensors of different types, and also relates to a seafloor observation system, a control method, and a program.

In general, a seafloor observation apparatus generates measurement results (observation data) of physical values of interest by using coefficients or the like that are obtained in advance by calibrating sensor signals output from sensors installed therein. Environments in which seafloor observation apparatuses are installed differ from each other due to the difference between places or water depths at which the seafloor observation apparatuses are installed. Therefore, in order to accurately measure actual physical values, it is essential to presume (e.g., predict) the environment in which the seafloor observation apparatus will be installed in advance and to use optimal conversion formulas and optimal coefficients according to the presumed (e.g., predicted) environment. Therefore, in order to generate observation data by using the seafloor observation apparatus, it is necessary to perform data processing according to the environment.

As one of the simplest methods, there is a method in which sensors are distinguished from each other according to the place where the corresponding seafloor observation apparatus is installed, and a calibration is performed according to the presumed (e.g., predicted) environment of the place where the corresponding seafloor observation apparatus is installed. In this case, before a sensor is shipped as a product, the calibration conditions of the sensor are changed according to the environment in which the sensor will be actually installed, and then observation data are generated in the seafloor observation apparatus in which the sensor is provided. However, in this method, operations or the like required for the calibration increase, and the calibration needs to be performed under the same conditions when a failure occurs after the original calibration, thus causing a problem that the cost of the calibration increases.

Further, since it is necessary to individually link each sensor to a corresponding seafloor observation apparatus to be installed, it becomes difficult to replace a component(s) when a failure occurs. Further, when the installation environment, such as a water depth, a temperature, or an inclination, is different from the presumed (e.g., predicted) environment, there is a possibility that accurate observation data cannot be obtained under the calibration conditions of the sensor which were changed in advance according to the presumed (e.g., predicted) environment.

In order to solve the problem in regard to the cost, it is desirable that the hardware factors of seafloor observation apparatuses, such as the calibration conditions of sensors, be the same as each other, and that corrections be made when data processing is performed. As a method according to this desirable way, there is a method in which data processing for corrections according to the situation of the surrounding environment is incorporated into the conversion formula for sensor signals. While this method can solve the above-described problem in regard to the hardware cost, it causes a new problem that the load (e.g., amount) of data processing increases. In an example, a land station receives sensor signals from a plurality of seafloor observation apparatuses and performs data processing on the received sensor signals.

In some cases, a seafloor observation system is used to observe a disaster (e.g., the situation caused by a disaster), and in such use, it is necessary to perform data processing in real time. When all such data processing is performed at a land station, the land station has to receive a plurality of types of sensor signals from a number of seafloor observation apparatuses and perform complicated processing. When sensor signals are processed at the land station and more accurate corrections are made to observation data by taking the influence of the place where the seafloor observation apparatus is installed into consideration, the load (e.g., amount) of data processing at the land station increases even further.

Therefore, it is conceivable to adopt, as a method for obtaining accurate observation data without performing complicated data processing at a land station, a method in which data of sensors installed in a seafloor observation apparatus are processed in that seafloor observation apparatus. In this way, it is expected to solve the problem in regard to the overload at the land station. However, in the case where the processing of data output from sensors is completed in the seafloor observation apparatus, there is a problem that it cannot cope with such a situation that it is desired to update coefficients or details of processing because the surrounding environment is different from the one that has been presumed (e.g., predicted) before the installation, or cannot cope with such a situation that a better data processing method is desired to be introduced after the installation. In order to solve the above-described problems, the inventors of the present application have contrived the following method.

### First Example Embodiment

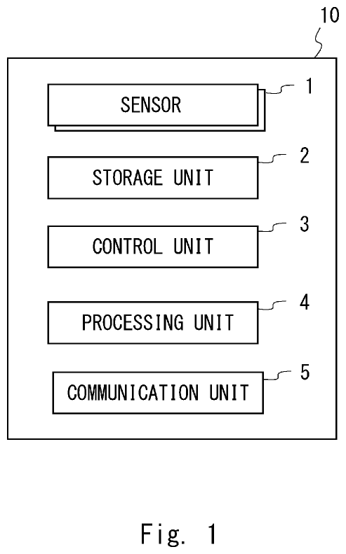

FIG. 1 is a block diagram showing a functional configuration of a seafloor observation apparatus 10 according to a first example embodiment. A plurality of seafloor observation apparatuses 10 are installed on the seafloor in an observation sea area and are used in a seafloor observation system. The seafloor observation system has a configuration in which a land station installed on land is connected to the plurality of seafloor observation apparatuses installed on the seafloor through submarine cables.

As shown in FIG. 1, the seafloor observation apparatus 10 (i.e., each of the seafloor observation apparatuses 10) includes a plurality of sensors 1 including sensors of different types, a storage unit 2, a control unit 3, a processing unit 4, and a communication unit 5. The plurality of sensors 1 are installed under the sea in the observation sea area and may include, for example, a water pressure gauge, a velocity gauge, an accelerometer, and the like. Note that although one seafloor observation apparatus includes a plurality of types of sensors, it may also include a plurality of sensors of the same type for redundancy. The plurality of sensors 1 including sensors of different types output respective sensor signals different from each other. These sensor signals are used, for example, in order to observe a disaster (e.g., the situation caused by a disaster).

The storage unit 2 stores a plurality of pieces of software (e.g., a plurality of types of software programs) including an instruction set and data that used to perform data processing on sensor signals different from each other, output from the plurality of sensors 1. These pieces of software are used to perform predetermined data processing on each of the sensor signals output from the plurality of sensors 1, and thereby generate respective observation data. Examples of predetermined data processing performed on sensor signals include a process for correcting a coefficient(s) or the like, which has been obtained in advance by performing a calibration of a sensor, according to the environment in which the seafloor observation apparatus is installed, and a process for generating observation data from a sensor signal by using the corrected coefficient(s) or the like.

When sensor signals are input from the sensors 1, the processing unit 4 generates observation data by loading software stored in the storage unit 2 and performing processing on a sensor signal of each of the plurality of sensors by using this loaded software. The control unit 3 can update the software stored in the storage unit 2 as appropriate in response to update data transmitted from the land station through the submarine cable. When the update of the software installed in the seafloor observation apparatus 10 is completed, the processing unit 4 continues to perform the process for generating observation data by using the updated software. The communication unit 5 transmits the observation data generated by the processing unit 4 to the land station through the submarine cable.

As described above, in the first example embodiment, the storage unit 2 and the control unit 3 are provided in the seafloor observation apparatus 10, and the software that has been transmitted from the land station and used to perform data processing on sensor signals is installed in the seafloor observation apparatus 10. The control unit 3 performs, in cooperation with the storage unit 2, processing for generating observation data by performing data processing on sensor signals output from the sensors 1 installed in the seafloor observation apparatus 10. The generated observation data is transmitted to the land station.

The land station can analyze the received observation data and thereby generate update data for updating the software after the installation of the seafloor observation apparatus 10 according to the environment, such as a pressure and a temperature, in which the seafloor observation apparatus 10 was installed. The control unit 3 can reinstall optimal software based on the update data transmitted from the land station and apply the reinstalled optimal software to data processing performed thereafter. In this way, it is possible to solve the problem in regard to the overload at the land station, and perform accurate data processing on sensor signals output from a plurality of sensors even when the place where the seafloor observation apparatus is installed is different.

### Second Example Embodiment

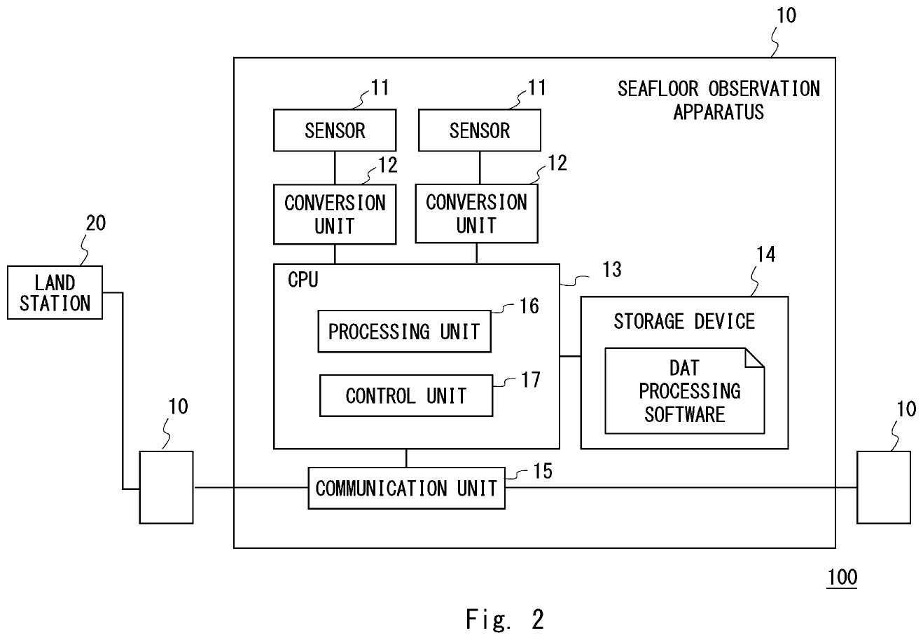

FIG. 2 shows a configuration of a seafloor observation system 100 according to a second example embodiment. The seafloor observation system 100 includes a plurality of seafloor observation apparatuses 10 and a land station 20. The plurality of seafloor observation apparatuses 10 are installed at respective places different from each other on the seafloor in an observation sea area. These seafloor observation apparatuses 10 are connected through submarine cables (not shown). The ends of the submarine cables are connected to the land station 20 installed on land.

The seafloor observation apparatus 10 (i.e., each of the seafloor observation apparatuses 10) includes sensors 11, conversion units 12, a CPU (Central Processing Unit) 13, a storage device 14, and a communication unit 15. The sensor 11 (i.e., each of the sensors 11) measures a physical value of the environment in which the seafloor observation apparatus 10 is installed, and thereby generates an analog sensor signal. The sensors 11 may be, for example, a water pressure gauge, a velocity gauge, an accelerometer, and the like. When the sensor 11 (i.e., one of the sensors 11) is an accelerometer, the sensor 11 may, for example, measure accelerations in three axial directions defined in a lateral direction (X-direction), a traveling direction (Y-direction), and a gravitational direction (Z-direction), and thereby generate analog acceleration data.

The sensor signal generated by the sensor 11 is input to the conversion unit 12 (i.e., the corresponding conversion unit 12). The converter 12 converts the analog sensor signal into a digital sensor signal and outputs the obtained digital sensor signal to the CPU 13. Example of digital sensor signals include a plurality of different types of signals such as water-pressure data, velocity data, acceleration data, and the like.

The storage device 14 is, for example, a storage device such as a hard disk drive or a flash memory. The storage device 14 stores data processing software for performing data processing on each of sensor signals output from the plurality of sensors 11. The data processing software includes a calculation formula for converting a digital sensor signal into observation data, which is a physical value of interest, a coefficient(s) included in the calculation formula, and the like.

Note that in FIG. 2, only the software related to the data processing for generating observation data from the sensor signal is shown as the software stored in the storage unit 2, and other software is not shown. Illustrations of, for example, an operating system, various types of middleware, application software, and the like that are executed on the respective devices are omitted.

The CPU 13 is a control apparatus that controls each component or the like of the seafloor observation apparatus 10. The CPU 13 implements the functions of a processing unit 16 and a control unit 17 by loading a program from the storage device 14 and executing the loaded program. The processing unit 16 executes data processing software (program) stored in the storage device 14, and thereby converts digital data received from each of the conversion units 12 into observation data of interest. Specifically, the processing unit 16 corrects acquired sensor signals according to the environment in which the seafloor observation apparatus 10 is installed. For example, for each sensor signal, the processing unit 16 generates observation data of a physical value of interest by using a coefficient(s), a conversion formula, and the like according to the water depth, the temperature, and the like of the environment in which the seafloor observation apparatus 10 is installed.

Further, when additional processing such as noise reduction is performed, the additional processing can be incorporated in the data processing software in advance. The processing unit 16 can perform additional processing simultaneously with (e.g., in parallel with) the conversion to physical values. After the processing using the data processing software is completed, the processing unit 16 transmits the generated observation data to the communication unit 15. The communication unit 15 converts the observation data, which has been delivered in the form of an electric signal, into an optical signal and transmits the optical signal to the land station 20 through the submarine cable.

The land station 20 analyzes the received observation data and determines whether or not the data processing performed in the seafloor observation apparatus 10 is appropriate. When the data processing performed in the seafloor observation apparatus 10 is not appropriate, the land station 20 generates update data for correcting the details of the data processing using the data processing software and transmits the generated update data in the form or an optical signal to the seafloor observation apparatus 10. Note that when it is determined that additional processing should be performed on the observation data after the installation of the seafloor observation apparatus 10, the land station 20 can transmit update data for correcting the data processing software to the seafloor observation apparatus 10 so that the additional processing is performed in the seafloor observation apparatus 10. When the data processing software is reinstalled, the land station 20 can transmit a software package for the reinstallation to the seafloor observation apparatus 10.

The communication unit 15 receives the optical signal by using a photodetector and converts the received optical signal into an electric signal. After the update data is converted into an electric signal, the update data, which is the electric signal, is transmitted to the control unit 17 of the CPU 13. The control unit 17 can update the data processing software according to the received update data. For example, the control unit 17 can update, by a received updated command, a coefficient(s) or the like that is included in the data processing software stored in the storage device 14 and is used when observation data is generated from a sensor signal(s). After that, the processing unit 16 can perform more appropriate data processing according to the installation environment by performing data processing on the sensor signal(s) using the updated data processing software.

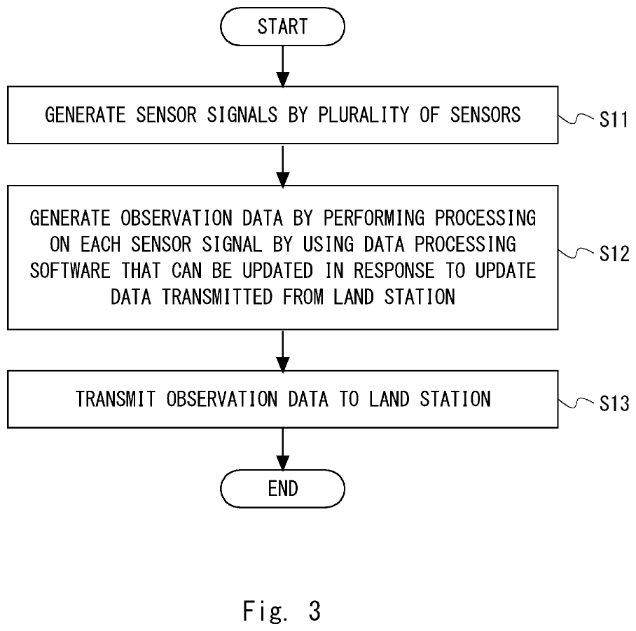

A method for controlling the seafloor observation system according to the second example embodiment will be described hereinafter with reference to FIG. 3. FIG. 3 is a flow diagram for explaining a method for controlling the seafloor observation system according to the second example embodiment. As shown in FIG. 3, firstly, sensor signals are generated by a plurality of sensors 11 including sensors of different types installed under the sea in an observation sea area (S11). Then, by using data processing software stored in the storage device 14, observation data is generated by performing data processing on a sensor signal of each of the plurality of sensors 11 (S12). This data processing software can be updated in response to update data transmitted from the land station 20 through the submarine cable. When the data processing software is updated by the update data, the processing unit 16 performs data processing on a sensor signal of each of the sensors 11 by using the updated data processing software.

Then, the communication unit 15 transmits observation data generated by the processing unit 16 to the land station 20 through the submarine cable (S13). The program in this example embodiment may be any program that causes a computer to perform the steps S11 to S13 shown in FIG. 3. By installing this program in the computer and executing the installed program, it is possible to implement the seafloor observation apparatus and the control method according to this example embodiment.

The program can be stored and provided to the seafloor observation apparatus 10 by using any type of non-transitory computer readable media. Examples of non-transitory computer readable media include magnetic recording media (e.g., flexible disks, magnetic tapes, and hard disk drives) and magneto-optical recording media (e.g., magneto-optical disks). Examples of non-transitory computer readable media also include CD-ROM (Read Only Memory), CD-R, and CD-R/W. Examples of non-transitory computer readable media also include semiconductor memories. Examples of semiconductor memories include mask ROM, PROM (Programmable ROM), EPROM (Erasable PROM), flash ROM, and RAM (Random Access Memory). Further, the program may also be supplied to the seafloor observation apparatus 10 by using various types of transitory computer readable media. Examples of transitory computer readable media include electrical signals, optical signals, and electromagnetic waves. The transitory computer readable media can supply the program to the seafloor observation apparatus 10 through a wired channel such as an electric wire and an optical fiber, or through a wireless channel.

As described above, the following effects can be obtained according to the example embodiments.

The first effect is to reduce the cost for hardware configuration.

The reason for this effect is that there is no need to use different hardware for the seafloor observation apparatus 10 according to the installation environment, and it is possible to use the same hardware for each of a plurality of seafloor observation apparatuses 10 when they are installed.

In the related method which is described previously for the comparison with the above-described example embodiments, it has been considered to perform a calibration according to the installation environment for achieving accurate observation. In such a method, it was expected that the calibration procedure would become more complicated and the cost would be higher than the case where the same calibration is performed for all the sensors. In contrast to this, in the example embodiments, since a method in which sensor signals are corrected according to the surrounding environment when data processing is performed on the sensor signals is adopted, it is possible to prevent the accuracy of the measurement from deteriorating, which would otherwise be caused by applying the same calibration, while also preventing the cost from increasing.

The second effect is that it is possible to perform data processing that is more suited to the environment in which the seafloor observation apparatus 10 is placed.

The environment in which the seafloor observation apparatus 10 is installed widely varies according to the place. Therefore, if the same data processing is performed in seafloor observation apparatuses 10 placed in different environments, an error inevitably occurs due to the difference between environments where the observation apparatuses are installed, resulting in errors in their measurement results. Further, it is known that the installation place of a seafloor observation apparatus 10 may be slightly deviated from the planned place when is it actually installed, which causes such a situation that the actual environmental conditions such as a water pressure, a temperature, and an inclination are different from those that are presumed (e.g., predicted) before the installation, and also possibly causing an error when data processing is performed.

In the example embodiments, to cope with such an error, it is possible to analyze results of data processing performed on sensor signals acquired by the sensors 11, and thereby update the software or the like for the data processing based on the result of the analysis, thus making it possible to perform more accurate data processing. Further, since it is possible to make corrections according to the individual environment by using the data processing software that has been updated by update data transmitted from the land station after the installation, such corrections can be made at a lower cost than the cost that is required to change the setting of each hardware. Further, there is another effect that additional processing that is performed on observation data, such as noise reduction processing, can be set and changed after the installation.

Note that the present disclosure is not limited to the above-described example embodiments, and they can be modified as appropriate without departing from the scope and spirit of the disclosure.

According to the present disclosure, it is possible to provide a seafloor observation apparatus, a seafloor observation system, a control method, and a program capable of performing accurate data processing on sensor signals output from a plurality of sensors even when the place where the seafloor observation apparatus is installed is different.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A seafloor observation apparatus comprising:
a plurality of sensors including sensors of different types installed under the sea in an observation sea area;
at least one memory storing instructions; and
at least one processor configured to execute the instructions, and thereby capable of:
making the memory store software used for data processing of sensor signals output from the plurality of sensors;
updating the software in response to update data transmitted from a land station through a submarine cable;
generating observation data by performing data processing of a sensor signal of each of the plurality of sensors by using the software; and
transmitting the observation data to the land station through the submarine cable.

2. The seafloor observation apparatus according to claim 1, wherein the at least one processor is further configured to execute the instructions, and thereby to update the software in response to the update data, the update data being generated by the land station based on a result of an analysis of the observation data.

3. The seafloor observation apparatus according to claim 1, wherein the update data is data for changing at least one of a conversion formula and a coefficient according to an environment in which the seafloor observation apparatus is installed.

4. The seafloor observation apparatus according to claim 1, wherein the at least one processor is further configured to be able to add additional processing other than the processing for generating the observation data from the sensor signals by using data transmitted from the land station through the submarine cable.

5. A control method wherein a computer performs:
a process for generating sensor signals by using a plurality of sensors including sensors of different types installed under the sea in an observation sea area;
a process for generating observation data by performing processing on a sensor signal of each of the plurality of sensors by using software used to process sensor signals output from the plurality of sensors, the software being updatable in response to update data transmitted from a land station through a submarine cable; and
a process for transmitting the observation data to the land station through the submarine cable.

6. A non-transitory computer readable medium storing a program for causing a computer to perform:
a process for generating sensor signals by using a plurality of sensors including sensors of different types installed under the sea in an observation sea area;
a process for generating observation data by performing processing on a sensor signal of each of the plurality of sensors by using software used to process sensor signals output from the plurality of sensors, the software being updatable in response to update data transmitted from a land station through a submarine cable; and
a process for transmitting the observation data to the land station through the submarine cable.
